(19) United States
(12) Patent Application Publication
(10) Pub. No.: US 2001/0053125 A1
(43) Pub. Date: Dec. 20, 2001

(54) Fail-over circuit for voice-enabled switch

(76) Inventors: Harry Staples, Simi Valley, CA (US); Mike Parkhurst, Newbury Park, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/827,022

(22) Filed: Apr. 4, 2001

Related U.S. Application Data
(60) Provisional application No. 60/194,637, filed on Apr. 4, 2000.
(60) Provisional application No. 60/194,658, filed on Apr. 4, 2000.
(60) Provisional application No. 60/196,275, filed on Apr. 4, 2000.

(51) Int. Cl. H04J 1/16; H04L 12/66

(52) U.S. Cl. 370/217; 370/353

(57) ABSTRACT

A voice-enabled switching node having a fail-over circuit. The switching node receives an inbound telephone call and internally routes the call for transmitting to a data network if no failure conditions have been encountered. Failure conditions may include power failures or failures on the switching node. If a failure has occurred, the switching node redirects the inbound telephone call to the voice switch for transmitting the call over a telephone network.

### CROSS-REFERENCE TO RELATED APPLICATIONS

This application claims the benefit of U.S. provisional applications Nos. 60/194,637, 60/194,658 and 60/196,275, all filed Apr. 4, 2000, the contents of which are incorporated herein by reference.

### FIELD OF THE INVENTION

This invention relates generally to data communication switches, and more particularly to data communication switches that support both voice and data traffic.

### BACKGROUND OF THE INVENTION

Data communication switches referred to as convergence switches support voice and data traffic in the same switch. A primary application for convergence switches is the routing of telephone calls placed within an enterprise over a leased data line rather than the public telephone network. Such reduction of usage the public telephone network may generally result in substantial cost savings.

Convergence switches come in generally two types: (1) data-enhanced voice switches, such as, for example, circuit switches with data adapters; and (2) voice-enhanced data switches, such as, for example, packet switches with voice adapters. Switches of the latter type, that is, voice-enhanced data switches, have certain advantages, such as reduction of wasted bandwidth resulting from unused time slots, greater flexibility in bandwidth allocation and per packet accounting and billing capability. However, one notable disadvantage of voice-enhanced data switches is their unreliability. Data switches have historically been subject to frequent crashes. Such frequent crashes do not sit well with users who have become accustomed to placing telephone calls over an extremely reliable public telephone network.

Accordingly, there is a need for a voice-enhanced data communication switch providing reliable telephone services even upon occurrence of failure conditions. Such a switch should redirect inbound telephone calls to the public telephone network upon occurrence of a particular failure condition, and resume transmission of the telephone calls over the leased data line upon recovery from such failure condition.

### SUMMARY OF THE INVENTION

The present invention is directed to a fail-over circuit in a communication switch. In one embodiment of the invention, the fail-over circuit passes inbound signals for transmission on a data network when the circuit is in a first state and redirects the inbound signals for transmission on a telephone network when the circuit is in a second state. In one example, the inbound signals are non-local telephone calls.

In another embodiment of the invention, a voice communication network comprises a communication switch and a telephone network connection coupled to the data communication switch, characterized in that the communication switch redirects inbound signals to the telephone network connection upon occurrence of an operational condition. Exemplary operational conditions include failure conditions, transmission errors, power loss, malfunction of a portion of the communication switch, and the like.

In a further embodiment of the invention, a communication switch in a voice communication network includes an input for receiving an inbound first signal, a circuit transitioning from a first state to a second state, and a processor coupled to the circuit. The processor is configured to detect an occurrence of an operational condition and transmit a second signal to the circuit to transition from the first state to the second state. The data communication switch further includes a first output transmitting the inbound first signal over a data network if the circuit is in the first state, and a second output transmitting the inbound first signal over a telephone network if the circuit is in the second state.

In yet another embodiment of the invention, a method for transmitting an inbound signal includes receiving the inbound signal, transitioning the fail-over circuit from a first state to a second state, passing the inbound signal for transmission on a data network if the fail-over circuit is in the first state, and redirecting the inbound signal for transmission on a telephone network if the fail-over circuit is in the second state.

In an additional embodiment of the invention, a communication network includes a communication switch, a data network connection coupled to the communication switch, and a telephone network connection coupled to the communication switch. The communication switch routes inbound signals on the data network connection prior to occurrence of a failure condition.

In a further embodiment of the invention, the communication switch redirects inbound signals to the telephone network connection after the occurrence of the failure condition.

It should be appreciated, therefore, that the present invention allows telephone calls to continue to be processed without significant interruption in service even if failure conditions occur.

### DESCRIPTION OF THE DRAWINGS

These and other features, aspects and advantages of the present invention will be more fully understood when considered with respect to the following detailed description, appended claims, and accompanying drawings where:

FIG. 1 is a schematic block diagram of a voice communication network including a voice-enhanced switching node according to one embodiment of the invention;

FIG. 2 is a more detailed schematic block diagram of the switching node of FIG. 1 according to one embodiment of the invention;

FIG. 3 is a schematic block diagram of a processor in the switching node of FIG. 1 according to one embodiment of the invention;

FIG. 4 is a process flow diagram of a process for triggering a fail-over circuit according to the embodiment of FIG. 3;

FIG. 5 is a schematic block diagram of a processor in the switching node of FIG. 1 according to an alternative embodiment of the invention; and

FIG. 6 is a process flow diagram of a process for triggering a fail-over circuit according to the embodiment illustrated in FIG. 5.

### DESCRIPTION OF THE INVENTION

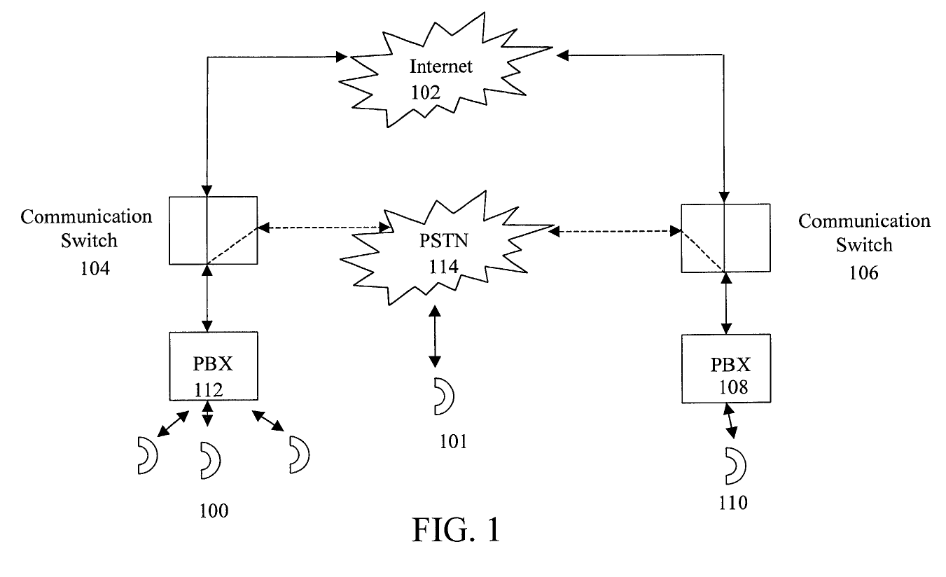

FIG. 1 is a schematic block diagram of a voice communication network according to one embodiment of the invention. The voice communication network includes switching nodes 104, 106 transmitting and receiving telephone calls to and from telephones 100, 101, 110, over a data network 102. Switching nodes 104, 106 also transmit and receive telephone calls over a telephone network 114.

The voice communication network includes voice switch 112 coupled to switching node 104 for managing incoming and outgoing telephone calls associated with telephone 100. In addition, the voice communication network includes voice switch 108 coupled to switching node 106 for managing incoming and outgoing telephone calls associated with telephone 110.

The telephone network 114, is preferably a public switched telephone network (PSTN). The data network 102 may be a local area network, private wide area network, or public wide area network such as, for example, the Internet. Switching nodes 104, 106 are preferably voice-enhanced gateway devices, such as, for example, voice-enhanced switches or routers, supporting both voice and data traffic within each node. Switching nodes 104, 106 may also be referred to as communication switches, voice-enhanced data switches, or voice-enabled switches. Voice switches 108, 112 are preferably private branch exchange (PBX) units or any other call management/switching units.

In general terms, a non-local telephone call from telephone 100 to telephone 110 is transmitted by the switching node 104 over the data network 102. In this regard, an inbound signal from telephone 100 is received by voice switch 112 and handed to switching node 104. The inbound signal is preferably a telephone call signal which may include voice, data, video, audio, and the like. Switching node 104 converts the signal into data packets and transmits the data packets to the data network 102. The data network carries the data packets to switching node 106. Switching node 106 receives the data packets and preferably translates them into voice signals. The voice signals are then transmitted to receiving telephone 110 by voice switch 108.

In the event of an operational condition on switching node 104, such as, for example, a failure condition, the call initiated by telephone 100 is not transmitted over the data network 102, but redirected to the telephone network 114. In this regard, the inbound signal from telephone 100 is received by voice switch 112 and handed to switching node 104. Switching node 104 transmits the signal via the telephone network 114. Voice-enhanced data switch 106 receives the signal from the telephone network 114, and transmits it to telephone 110 through the voice switch 108. Once switching node 104 is restored to its normal operating condition, telephone calls are again routed over the data network 102. It should be appreciated, therefore, that telephone calls may continue to be processed without significant interruption in service even if a failure occurs on switching node 104.

If voice-enhanced data switch 106 has not encountered failure conditions, it may receive calls from both the data network 102 and the telephone network 114. However, if voice-enhanced data switch 106 has encountered a failure condition, the switch may continue to route calls received from the telephone network 114, but calls received from the data network 102 cannot be processed. In the latter case, switching node 104 recognizes that calls are not reaching their destination, and redirects the calls to the telephone network 114. Once switching node 106 is restored to its normal operating condition, it may again receive telephone calls from the data network 102.

If the operational condition is a request for a local host, such as, for example, telephone 101, in conducting a local telephone call, the call is transmitted from telephone 100 to the voice switch 112 which in turn transmits it to switching node 104. Switching node recognizes the call as a local call, and switches the call to the telephone network 114.

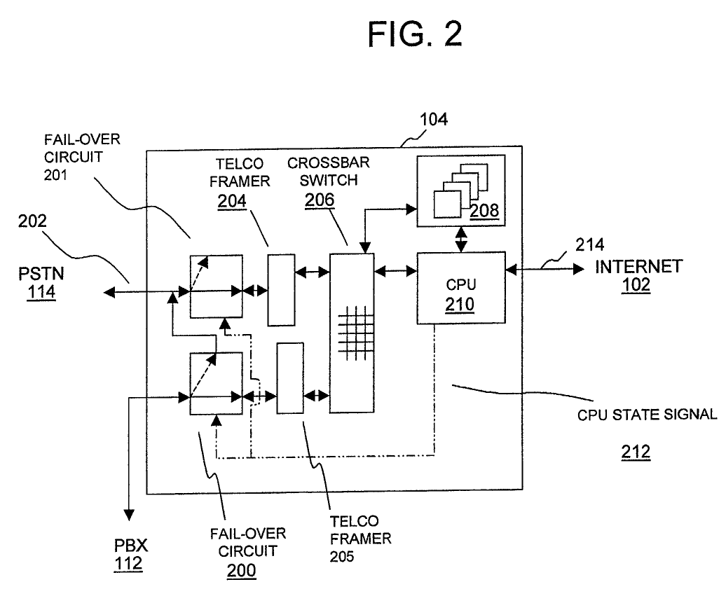

FIG. 2 is a more detailed schematic block diagram of switching node 104 according to one embodiment of the invention. Switching node 104 is representative of switching node 106. For exemplary purposes, it is assumed that switching node 104 receives inbound calls from the voice switch 112. A person skilled in the art should recognize, however, that the present invention also applies for inbound calls received from the telephone network 114 and data network 102.

Switching node 104 preferably includes fail-over circuits 200, 201 respectively receiving inbound signals from the voice switch 112 and transmitting outbound signals to the telephone network 114. The signals are received and transmitted over telephone connections 202, 203 such as, for example, RJ11, RJ45, or RJ48 connections. Voice data in the inbound and outbound signals is preferably transmitted in a time-division multiplexed (TDM) stream according to conventional methods.

The fail-over circuits 200, 201 preferably take the form of electro-mechanical relays conventional in the art. The fail-over circuits 200, 201 may further take the form of solid state relays also conventional in the art. The fail-over circuits 200, 201 preferably transition from an active (open) state to an inactive (closed) state upon occurrence of an operational condition. If the operational condition is a power loss, the relays drop into their inactive state, connecting the voice switch 112 to the telephone network 114. When the power is restored, the fail-over circuit is restored to its active state, preferably as part of the power-up sequence undertaken by the switching node 104, and signals may again be routed over the data network 102. The fail-over circuit may also be restored to its active state upon reset of the switching node 104.

If the operational condition is a malfunction of the switching node 104 or due to a transmission error, the fail-over circuit 200 receives a CPU state signal 212 which de-activates the relays and connects the voice switch 112 to the telephone network 114. The relays may be activated manually or automatically upon correction of the malfunction, causing telephone calls to be routed again over the data network 102.

The switching node 104 further includes framer 204, 205 chips processing inbound and outbound signals. Preferably, framer 204 attaches frame data to outbound voice data directed to the telephone network 114, and strips frame data from inbound voice data coming from the voice switch 112. The frame data may include embedded clocks, signaling data such as, for example, off-hook and dial-tone, TDM data such as, for example, error-checksums and sync bits, and the like.

The switching node 104 also includes a crossbar switch 206 coupled to framers 204, 205 for relaying data to and from the telephony side of the switching node. The crossbar switch 206 further routes local calls received from the voice switch 112 to the telephone network 114 during normal operating conditions.

The crossbar switch 206 is preferably an any-to-any type of switch feeding any voice channel within the TDM stream to any signal processor (DSP) 208 port for voice processing for calls to be routed over the data network 102. The DSP 208 preferably processes voice data by, for example, compressing/decompressing them, filtering noise, and/or monitoring an associated quality of service. The processed voice data is transmitted to a processor 210 for packetizing into voice data packets, preferably according to a Real Time Protocol (RTP) conventional in the art. The processor preferably transmits the voice data packets to the data network 102 over a network connection 214. The network connection may take a variety of forms, including fibre optic, twisted pair, coaxical cables, and the like. A variety of network standards and protocols may be used to transmit the voice data packets, including TCP/IP, UDP/IP, ATM, Ethernet, and other Layer 2 (Data Link/MAC Layer), Layer 3 (Network Layer), or Layer 4 (Transport Layer) standards and protocols.

In general terms, voice is transmitted via a voice channel within a TDM stream. This stream is then transmitted from the voice switch 112 to the switching node 104. The stream is transmitted to the framer chip 205 or telephone network 114 based on whether the fail-over circuit 200 is in an active (open) or inactive (closed) state. If the fail-over circuit 200 is in an inactive state, it preferably connects to the telephone network 114. In this scenario, the stream is passed to the telephone network 114 via the telephone connection 202 for transmission according to conventional methods. Once the switching node 104 is restored to its normal operating condition, the fail-over circuit preferably transitions from the inactive state to the active state.

If the fail-over circuit 200 is in an active state, it preferably couples to framer 205. In this latter scenario, the stream is passed to framer 205 for preferably stripping the embedded clock, error checking the data, and separating signaling data from voice data. The simplified TDM stream is then transmitted to the crossbar switch. If the call is a local call, the crossbar switch 206 switches the call to framer 204 which re-attaches the frame data to the stream, and transmits it to fail-over circuit 201 for routing over the telephone network 114.

If the call is a non-local call, the crossbar switch 206 switches the voice channel to a particular DSP 208 allocated by the processor 210 for voice processing. The DSP 208 processes the voice data and transmits it to the processor 210. The processor 210 packetizes the data into voice data packets. The voice data packets are preferably converged with other data packets and sent over the data network 102 via the network connection 214.

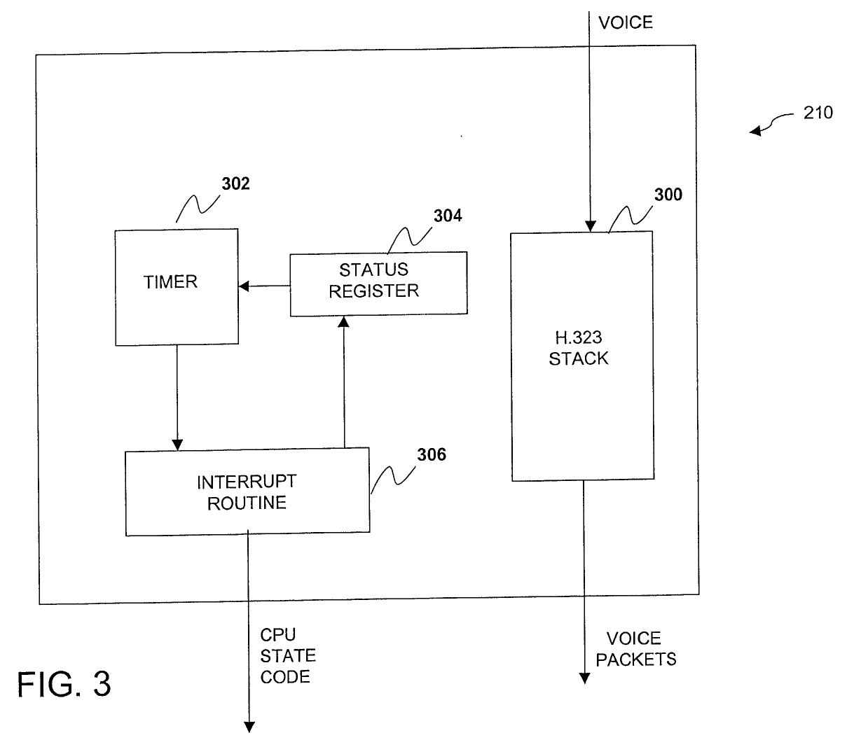

FIG. 3 is a schematic block diagram of the processor 210 according to one embodiment of the invention. The processor includes an Internet telephony protocol stack 300 for establishing/tearing down Internet telephony calls over the data network 102. The Internet telephony protocol used by the processor 210 may be H.323 or other protocol known to those skilled in the art.

The processor further includes a timer 302, a status register 304, and an interrupt routine 306. The timer 302 is preferably a watchdog timer programmed to invoke the interrupt routine at fixed intervals, such as, for example, every 100 milliseconds. The interrupt routine 306 is preferably a software routine programmed to output the CPU state signal 212 to the framer 204. The status register 304 preferably includes a flag indicative of the status of the switching node 104.

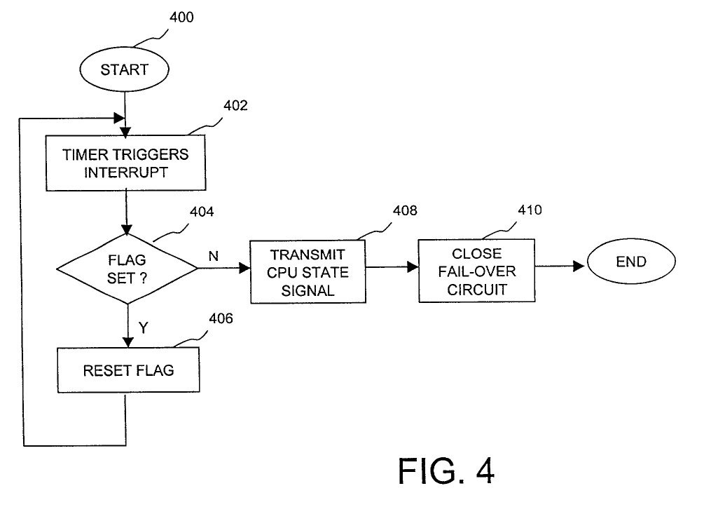

FIG. 4 is a process flow diagram of a process for triggering the fail-over circuit 200, 201 according to the embodiment of FIG. 3 in the event of a failure condition. Although the flow diagram is described in terms of a software process, a person skilled in the art should realize that the process may also be carried out in hardware, firmware, or any combination thereof.

In step 402, the timer 302 triggers the interrupt routine 306. In step 404, the interrupt routine 306 determines if a keep-alive flag on the status register 304 is set. Normal operating code preferably sets the flag periodically indicating normal operating conditions. If the flag is set, the interrupt routine 306, in step 406, resets the flag indicating that no error conditions have been encountered.

If, however, a failure or some other malfunction condition has been encountered, the flag is not set, and in step 408, the interrupt routine 306 transmits the CPU state signal 212 to the fail-over circuit 200, 201. Upon receipt of the CPU state signal 212, the fail-over circuit 200, 201, in step 410, switches from an active (open) state to an inactive (closed) state.

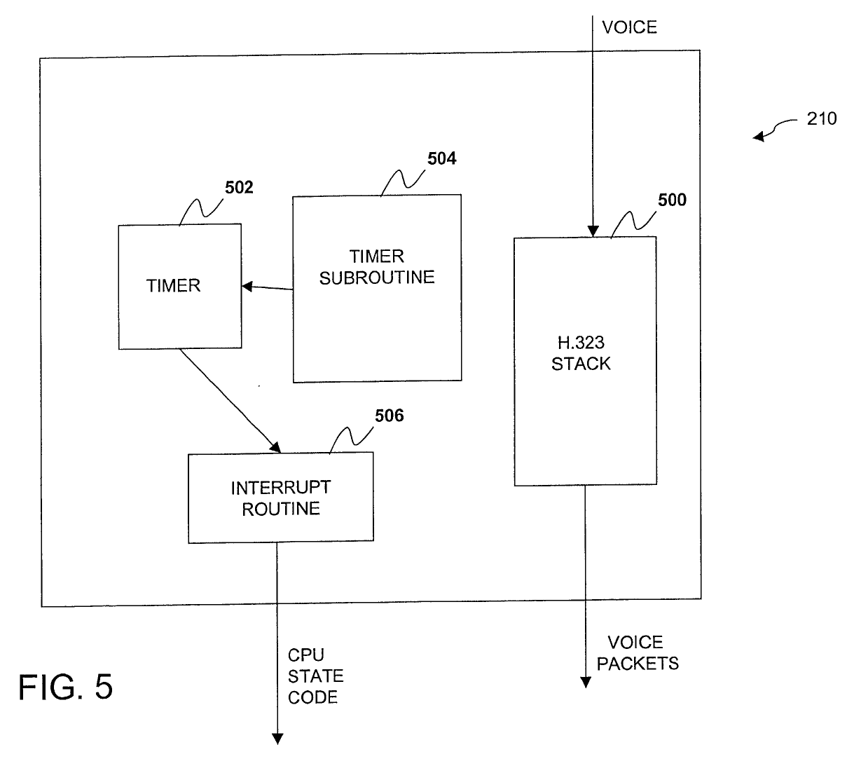

FIG. 5 is a schematic block diagram of the processor 210 according to an alternative embodiment of the invention. The processor includes an Internet telephony protocol stack 500 which may be similar to the Internet telephony protocol stack of FIG. 3. The processor further includes a timer 502, timer subroutine 504, and an interrupt routine 506. The timer is preferably a countdown timer programmed to count down from a predetermined time value. The timer subroutine 504 is preferably a software routine programmed to periodically reset the timer to the predetermined time value. The timer subroutine 504 may also be a hardware, firmware or other routine known in the art to periodically reset the timer to the predetermined time value. The interrupt routine 506 is preferably a software routine programmed to output the CPU state signal 212 to the framer 204. The interrupt routine 506 may also be a hardware, firmware or other routine known in the art to output the CPU state signal 212 to the framer 204.

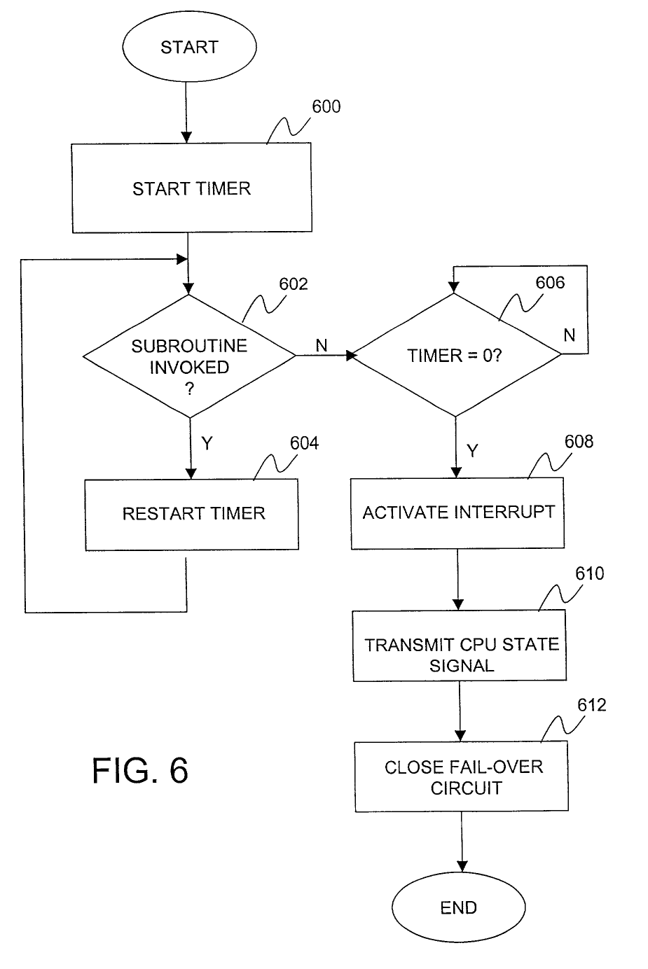

FIG. 6 is a process flow diagram of a process for triggering the fail-over circuit 200, 201 according to the embodiment illustrated in FIG. 5 in the event of a failure condition. Although the flow diagram is described in terms of a software process, a person skilled in the art should realize that the process may be carried out in hardware, firmware, or any combination thereof.

In step 600, the timer subroutine 504 causes the timer 502 to start counting down from the predetermined timer value. In the event of no failure conditions, the timer subroutine 504 restarts the timer 502 on a periodic basis. Accordingly, in steps 602 and 604, if the subroutine has been invoked, the timer is restarted. However, with reference to steps 606 and 608, if a failure condition is encountered that prevents the subroutine from being invoked, the timer 502 counts down to zero, and the interrupt routine 506 is activated. The interrupt routine preferably transmits the CPU state signal 212 to the fail-over circuit 200, 201 in step 610. Upon receipt of the CPU state signal 212, the fail-over circuit 200, 201, in step 612, switches from an active (open) state to an inactive (closed) state.

It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

What is claimed is:

1. A communication switch having a fail-over circuit, characterized in that the circuit passes inbound signals for transmission on a data network when the circuit is in a first state and redirects the inbound signals for transmission on a telephone network when the circuit is in a second state.

2. The communication switch of claim 1, wherein the inbound signals are non-local telephone calls.

3. The communication switch of claim 1, further characterized in that the circuit passes inbound local signals directed to a local host to an internal switch for internally routing the inbound local signals to the telephone network when the circuit in the first state.

4. The communication switch of claim 3, wherein the inbound local signals are local telephone calls.

5. The communication switch of claim 1, characterized in that the circuit transitions from the first state to the second state upon occurrence of an operational condition.

6. The communication switch of claim 5, wherein the operational condition is a failure condition.

7. The communication switch of claim 5, wherein the operational condition is a transmission error.

8. The communication switch of claim 5, wherein the operational condition is power loss.

9. The communication switch of claim 5, wherein the operational condition is a malfunction of a portion of the communication switch.

10. A voice communication network comprising:
a communication switch; and
a telephone network connection coupled to the communication switch, characterized in that the communication switch redirects inbound signals to the telephone network connection upon occurrence of an operational condition.

11. The voice communication network of claim 10, wherein the switch includes a fail-over circuit for redirecting the inbound signals to the telephone network connection.

12. The voice communication network of claim 10, wherein the inbound signals are non-local telephone calls.

13. The voice communication network of claim 10, further characterized in that the communication switch passes the inbound signals to the telephone network connection if the inbound signals are local telephone calls directed to a local host.

14. The voice communication network of claim 13, wherein the communication switch includes an internal switch for passing the local telephone calls to the network telephone connection.

15. The voice communication network of claim 10, wherein the operational condition is a failure condition.

16. The voice communication network of claim 10, wherein the operational condition is a transmission error.

17. The voice communication network of claim 10, wherein the operational condition is power loss.

18. The voice communication network of claim 10, wherein the operational condition is a malfunction of a portion of the communication switch.

19. A communication switch in a voice communication network comprising:
an input for receiving an inbound first signal;
a circuit transitioning from a first state to a second state;
a processor coupled to the circuit, the processor configured to detect an occurrence of an operational condition and transmit a second signal to the circuit for transitioning the circuit from the first state to the second state;
a first output transmitting the inbound first signal over a data network if the circuit is in the first state; and
a second output transmitting the inbound first signal over a telephone network if the circuit is in the second state.

20. The communication switch of claim 19, wherein the operational condition is a failure condition.

21. The communication switch of claim 19, wherein the operational condition is a transmission error.

22. The communication switch of claim 19, wherein the operational condition is a malfunction of a portion of the communication switch.

23. The communication switch of claim 19, wherein the operational condition is power loss.

24. The communication switch of claim 19, wherein the inbound first signal is a non-local telephone call.

25. The communication switch of claim 19, wherein the second signal is a transitioning signal for transitioning the circuit.

26. The communication switch of claim 19 further including an internal switch for transmitting inbound local signals directed to a local host to the telephone network when the circuit is in the first state.

27. The communication switch of claim 19, wherein the inbound local signals are local telephone calls.

28. In a voice communication network including a communication switch having a fail-over circuit, a method for transmitting an inbound first signal comprising the steps of:
receiving the inbound first signal;
transitioning the fail-over circuit from a first state to a second state;
passing the inbound first signal for transmission on a data network if the fail-over circuit is in the first state; and
redirecting the inbound telephone call for transmission on a telephone network if the fail-over circuit is in the second state.

29. The method of claim 28 further comprising the steps of:
detecting an operational condition; and
transmitting a second signal to the fail-over circuit to transition from the first state to the second state upon detecting the operational condition.

30. The method of claim 29, wherein the operational condition is a failure condition.

31. The method of claim 29, wherein the operational condition is a transmission error.

32. The method of claim 29, wherein the operational condition is a malfunction of a portion of the communication switch.

33. The method of claim 29, wherein the operational condition is power loss.

34. The method of claim 29, wherein the second signal is a transitioning signal for transitioning the fail-over circuit.

35. The method of claim 28, wherein the inbound first signal is a non-local telephone call.

36. The method of claim 28 further comprising the steps of:
receiving an inbound local signal; and
passing the inbound local signal to an internal switch for internally routing the local signal to the telephone network when the circuit is in the first state.

37. A communication network comprising:
a communication switch;
a data network connection coupled to the communication switch; and
a telephone network connection coupled to the communication switch characterized in that the communication switch routes inbound signals on the data network connection prior to occurrence of a failure condition.

38. The communication network of claim 37, further characterized in that the communication switch redirects inbound signals to the telephone network connection after the occurrence of the failure condition.
